(19) United States
(12) Patent Application Publication
(10) Pub. No.: US 2024/0322133 A1
(43) Pub. Date: Sep. 26, 2024

(54) CATHODE ACTIVE MATERIAL FOR LITHIUM SECONDARY BATTERY, LITHIUM SECONDARY BATTERY, AND METHOD FOR MANUFACTURING CATHODE ACTIVE MATERIAL

(71) Applicant: HONDA MOTOR CO., LTD., Tokyo (JP)

(72) Inventors: Kazuki CHIBA, Saitama-ken (JP); Kazumasa SAKATSUME, Saitama-ken (JP); Takashi HAKARI, Saitama-ken (JP); Akihisa TANAKA, Saitama-ken (JP); Yoshiya FUJIWARA, Saitama-ken (JP); Yoshiyuki MORITA, Saitama-ken (JP)

(21) Appl. No.: 18/589,483

(22) Filed: Feb. 28, 2024

(30) Foreign Application Priority Data
Mar. 20, 2023 (JP) 2023-044683

(51) Int. Cl. H01M 4/36; C01G 53/00; H01M 4/02; H01M 4/131; H01M 4/505; H01M 4/525; H01M 10/052

(52) U.S. Cl. CPC H01M 4/366; C01G 53/50; H01M 4/131; H01M 4/505; H01M 4/525; H01M 10/052; C01P 2002/72; C01P 2002/74; C01P 2002/86; C01P 2006/40; H01M 2004/028

(57) ABSTRACT

A cathode active material for a lithium secondary battery contains a lithium transition metal composite oxide as a main component, the lithium transition metal composite oxide is in a form of particles having a layered structure of a lithium layer and a transition metal-lithium layer, the lithium transition metal composite oxide is expressed by General Formula (1) LiₘNiₓMn_{y}Ti_{z}O₂ (in the formula, m is in a range of 1.0<m≤1.1, x is in a range of 0.4≤x<0.5, y is in a range of 0.3<y<0.5, and z is in a range of 0<z≤0.133), and as lattice constants (a, c, and c/a) of the lithium transition metal composite oxide, an a-axis length is 2.886 Å to 2.900 Å, a c-axis length is 14.29 Å to 14.35 Å, and c/a is 4.940 to 4.960.

### BACKGROUND

### Technical Field

The present invention relates to a novel cathode active material for a lithium secondary battery, a lithium secondary battery using the cathode active material, and a method for manufacturing a cathode active material for a lithium secondary battery.

### Background Art

In recent years, research and development on secondary batteries that contribute to improvement of energy efficiency have been conducted. In particular, lithium secondary batteries are becoming increasingly important as power sources for electric vehicles (EV), hybrid electric vehicles (HEV), and the like.

A cathode active material has attracted attention as an important component for determining the capacity of a lithium secondary battery, and development thereof has been advanced. As a cathode active material used for a lithium secondary battery, for example, a nickel-manganese-based composite oxide has been reported (refer to Mitsuharu Tabuchi, Riki Kataoka, and Koji Yazawa, “High-Capacity Li-excess lithium nickel manganese oxide as a Co-free positive electrode material”, Materials Research Bulletin, 137 (2021) 111178), and a nickel-manganese-titanium-based composite oxide has been reported (refer to J. S. Kim, C. S. Johnson, M. M. Thackeray “Layered xLiMO₂·(1-x)Li₂M′O₃ electrodes for lithium batteries: a study of 0.95LiMn_{0.5}Ni_{0.5}O₂·0.05Li₂TiO₃”, Electrochemistry Communications 4 (2002) 205-209, JP 2022-60167 A, and JP 2008-12733 A).

### CITATION LIST

### Patent Literature

Patent Literature 1: JP 2022-60167 A
Patent Literature 2: JP 2008-12733 A

### Non Patent Literature

Non Patent Literature 1: Mitsuharu Tabuchi, Riki Kataoka, and Koji Yazawa, “High-Capacity Li-excess lithium nickel manganese oxide as a Co-free positive electrode material”, Materials Research Bulletin, 137 (2021) 111178
Non Patent Literature 2: J. S. Kim, C. S. Johnson, M. M. Thackeray “Layered xLiMO₂·(1-x)Li₂M′O₃ electrodes for lithium batteries: a study of 0.95LiMn_{0.5}Ni_{0.5}O₂·0.05Li₂TiO₃”, Electrochemistry Communications 4 (2002) 205-209

### SUMMARY

### Technical Problem

By the way, in a technology related to a lithium secondary battery, an object is to provide a cathode active material that does not use expensive cobalt having a resource risk, reduces the use amount of nickel as much as possible, and has excellent electrochemical characteristics.

The technology described in Mitsuharu Tabuchi, Riki Kataoka, and Koji Yazawa, “High-Capacity Li-excess lithium nickel manganese oxide as a Co-free positive electrode material”, Materials Research Bulletin, 137 (2021) 111178 is aimed at a cobalt-free cathode material, but in an XRD pattern of LiNi_{0.5}Mn_{0.5}O₂, any bimodal peak around 2θ=65° is tailed or not clearly separated. In addition, in ⁷Li pj-MATPASS NMR data, peaks due to Ni, Mn—Li, and Mn—Li in a transition metal layer having a honeycomb structure are recognized near 1350 ppm and 1500 ppm, respectively, and in a main peak, a peak due to a Mn domain close to Li in a Li layer near 700 nm and a shoulder peak due to a Ni domain close to Li in the Li layer near 533 ppm are also observed. These facts indicate that in the lithium transition metal composite oxide described in Mitsuharu Tabuchi, Riki Kataoka, and Koji Yazawa, “High-Capacity Li-excess lithium nickel manganese oxide as a Co-free positive electrode material”, Materials Research Bulletin, 137 (2021) 111178, the transition metals (Ni and Mn) are not uniformly dispersed and form phase separation or domains. This suggests that the electrochemical characteristics of the lithium transition metal composite oxide disclosed in Mitsuharu Tabuchi, Riki Kataoka, and Koji Yazawa, “High-Capacity Li-excess lithium nickel manganese oxide as a Co-free positive electrode material”, Materials Research Bulletin, 137 (2021) 111178 are low.

The technology described in J. S. Kim, C. S. Johnson, M. M. Thackeray “Layered xLiMO₂·(1-x)Li₂M′O₃ electrodes for lithium batteries: a study of 0.95LiMn_{0.5}Ni_{0.5}O₂·0.05Li₂TiO₃”, Electrochemistry Communications 4 (2002) 205-209 uses 0.95LiMn_{0.5}Ni_{0.5}O₂·0.05Li₂TiO₃ into which electrochemically inert Li₂TiO₃ is introduced for enhancing the stability of the LiNi_{0.5}Mn_{0.5}O₂ electrode as a cathode material. However, the XRD pattern of 0.95LiMn_{0.5}Ni_{0.5}O₂·0.05Li₂TiO₃ has a problem that a bimodal peak near 2θ=650 is not clearly separated, and a transition metal (Ni, Mn, or Ti) is not uniformly dispersed.

The technology described in JP 2022-60167 A suggests Li₁₊ₓ(Ni_{y}M_{z}Mn_{1-y-z})₁₋ₓO₂ (in the formula, M represents Mg and/or Ti) as a cobalt-free cathode material, and in an XRD pattern of the lithium transition metal composite oxide described in that same literature, a peak due to a Li₂MnO₃ domain is observed near 20=22°, and this indicates that a transition metal is not uniformly dispersed. In addition, the technology described in JP 2008-12733 A suggests a lithium transition metal composite oxide expressed by Li₁₊ₓ(Mn₁₋ₙ₋ₘNiₘTiₙ)₁₋ₓO₂ as a cobalt-free cathode material, but the lithium transition metal composite oxide described in the same literature includes a mixed phase of a crystal phase having a layered rock salt type structure and a crystal phase having a cubic rock salt type structure, and a chemical composition of the lithium transition metal composite oxide is not uniform.

An object of the invention is to provide a cobalt-free cathode material for a lithium secondary battery in which the amount of nickel used is reduced, and to solve a problem of deterioration in electrochemical characteristics due to non-uniform dispersion of transition metals found in the related art.

### Solution to Problem

To accomplish the above-described object, the invention provides the following means.

[1] A cathode active material for a lithium secondary battery containing a lithium transition metal composite oxide as a main component,
wherein the lithium transition metal composite oxide is in a form of particles having a layered structure of a lithium layer and a transition metal-lithium layer,
the lithium transition metal composite oxide is expressed by General Formula (1): LiₘNiₓMn_{y}Ti_{z}O₂ (in the formula, m is in a range of 1.0<m≤1.1, x is in a range of 0.4≤x<0.5, y is in a range of 0.3<y<0.5, and z is in a range of 0<z≤0.133), and
as lattice constants (a, c, and c/a) of the lithium transition metal composite oxide, an a-axis length is 2.886 Å to 2.900 Å, a c-axis length is 14.29 Å to 14.35 Å, and c/a is 4.940 to 4.960.

In the cathode active material for a lithium secondary battery of the invention, titanium (Ti) is added as a constituent element to LiNi_{0.5}Mn_{0.5}O₂ of the related art, and a part of Ni_{0.5}Mn_{0.5} is replaced with Li and Ti, and thus the use amount of Ni having a resource risk can be reduced while maintaining satisfactory electrochemical characteristics. In addition, when the cathode active material satisfies the range of the chemical composition and the range of the lattice constant of the lithium transition metal composite oxide expressed by General Formula (1), the transition metal is uniformly dispersed, whereby the charge and discharge capacity of the lithium secondary battery can be improved.

[2] The cathode active material for a lithium secondary battery according to [1], wherein in General Formula (1), m is in a range of 1.05≤m≤1.066, x is in a range of 0.4≤x≤0.475, y is in a range of 0.4≤y≤0.475, and z is in a range of 0.05≤z≤0.133.

When optimizing the chemical composition of the lithium transition metal composite oxide expressed by General Formula (1), dispersibility of the transition metal is further improved, and the charge and discharge capacity of the lithium secondary battery can be further increased.

[3] The cathode active material for a lithium secondary battery according to [1] or [2], wherein a ratio (Mn/Ni ratio) of the number of atoms of Mn to the number of atoms of Ni on a surface of the particles of the lithium transition metal composite oxide is more than 1.0 and less than 2.5.

When the surface of the particles of the lithium transition metal composite oxide is Mn-rich, the charge and discharge capacity of the lithium secondary battery can be increased in a case where the lithium transition metal composite oxide is used as a cathode active material of the lithium secondary battery.

[4] The cathode active material for a lithium secondary battery according to any one of [1] to [3], wherein a peak intensity ratio of 1500 ppm/600 ppm is 0.15 or less in a spectrum of the lithium transition metal composite oxide which is measured by solid lithium nuclear magnetic resonance analysis (⁶Li-MAS-NMR) using a magic angle sample rotation method.

When the peak intensity ratio of 1500 ppm/600 ppm in the solid lithium nuclear magnetic resonance spectrum is 0.15 or less, phase separation of the transition metal is suppressed. That is, when the transition metal is uniformly dispersed, the charge and discharge capacity of the lithium secondary battery can be increased in a case where the lithium transition metal composite oxide is used as a cathode active material of the secondary battery.

[5] The cathode active material for a lithium secondary battery according to any one of [1] to [4], wherein a peak due to lithium contained in the transition metal-lithium layer is not present at 1500 ppm in the spectrum of the lithium transition metal composite oxide which is measured by the solid lithium nuclear magnetic resonance analysis (⁶Li-MAS-NMR).

According to this, in a case where the lithium transition metal composite oxide is used as a cathode active material of a secondary battery, the charge and discharge capacity of the lithium secondary battery can be further increased.

[6] A lithium secondary battery including: a cathode; an anode; and an electrolyte, wherein the cathode contains the cathode active material for a lithium secondary battery according to [1].

In the lithium secondary battery of the invention, when the cathode contains a cathode active material containing the lithium transition metal composite oxide as a main component, the capacity can be increased.

[7] The lithium secondary battery according to [6], wherein the electrolyte is a solid electrolyte.

The cathode active material for a lithium secondary battery of the invention is applicable to an all-solid-state lithium secondary battery.

[8] A method for manufacturing a cathode active material for a lithium secondary battery according to [1], the method including:
heat-treating a mixture of a lithium compound, a titanium compound, and a nickel-manganese compound at 1000° C. to 1200° C. for 1 minute to 7 hours, or heat-treating a mixture of a lithium compound and a nickel-manganese-titanium compound at 1000° C. to 1200° C. for 1 minute to 7 hours.

A cathode active material for a lithium secondary battery satisfying the range of the chemical composition and the range of the lattice constant of the lithium transition metal composite oxide expressed by General Formula (1) can be manufactured by the method including the above-described processes.

[9] The method for manufacturing a cathode active material for a lithium secondary battery according to [8], further comprising: subsequently holding the obtained lithium transition metal composite oxide at 850° C. to 950° C. for 3 hours to 12 hours after the heat-treatming.

When the slow cooling process is further provided, the surface of the lithium transition metal composite oxide particles can be made rich in Mn.

### BRIEF DESCRIPTION OF DRAWINGS

FIG. 1 is a view illustrating ⁶Li-MAS-NMR spectra of lithium transition metal composite oxides of Examples 1 and 2;

FIG. 2 is a view illustrating ⁶Li-MAS-NMR spectra of lithium transition metal composite oxides of Examples 3 and 4;

FIG. 3 is a view illustrating powder X-ray diffraction patterns of lithium transition metal composite oxides of Examples 1 and 2;

FIG. 4 is a view illustrating powder X-ray diffraction patterns of lithium transition metal composite oxides of Examples 3 and 4;

FIG. 5 is a view illustrating charge and discharge curves in a lithium secondary battery using the lithium transition metal composite oxides of Examples 1 and 2;

FIG. 6 is a view illustrating charge and discharge curves in a lithium secondary battery using the lithium transition metal composite oxides of Examples 3 and 4;

FIG. 7 is an electron micrograph of lithium transition metal composite oxide particles of Example 3;

FIG. 8 is an electron micrograph of lithium transition metal composite oxide particles of Example 4;

FIG. 9 is a cross-sectional view schematically illustrating an example of a lithium secondary battery according to an embodiment of the invention;

FIG. 10 is a view illustrating a ⁷Li pj-MATPASS NMR spectrum of a lithium transition metal composite oxide (LiNi_{0.5}Mn_{0.5}O₂) shown in Mitsuharu Tabuchi, Riki Kataoka, and Koji Yazawa, “High-Capacity Li-excess lithium nickel manganese oxide as a Co-free positive electrode material”, Materials Research Bulletin, 137 (2021) 111178;

FIG. 11 is a view illustrating an X-ray diffraction pattern of the lithium transition metal composite oxide (LiNi_{0.5}Mn_{0.5}O₂) shown in Mitsuharu Tabuchi, Riki Kataoka, and Koji Yazawa, “High-Capacity Li-excess lithium nickel manganese oxide as a Co-free positive electrode material”, Materials Research Bulletin, 137 (2021) 111178; and

FIG. 12 is a view illustrating an X-ray diffraction pattern of a titanium-containing lithium nickel manganese-based composite oxide shown in JP 2022-60167 A.

### DETAILED DESCRIPTION

Hereinafter, preferred embodiments of the invention will be described in detail with reference to the accompanying drawings.

### [Cathode Active Material for Lithium Secondary Battery]

A cathode active material for the lithium secondary battery of the invention contains a lithium transition metal composite oxide as a main component, and is used for a cathode of the lithium secondary battery. The phrase “containing a lithium transition metal composite oxide as a main component” represents that the content of the lithium transition metal composite oxide is 75% by mass or more, preferably 80% by mass or more, more preferably 90% by mass or more, and still more preferably 99% by mass or more. The cathode active material for a lithium secondary battery may contain components other than the main component as long as the function of the present invention is not impaired.

The cathode active material for the lithium secondary battery of the invention may contain only one kind or two or more kinds of lithium transition metal composite oxides as long as the lithium transition metal composite oxide is contained as a main component.

When the cathode active material is manufactured by using the lithium transition metal composite oxide as a main component, a composition ratio (Li:Ni:Mn:Ti) of the entirety of the lithium transition metal composite oxide is also maintained in a cathode active material that is obtained. When the cathode active material obtained by using the lithium transition metal composite oxide having such a composition as a main component is used in a secondary battery, high capacity can be realized. In addition, the composition ratio of the lithium transition metal composite oxide is adjusted so as to be the same as a composition ratio required for the cathode active material to be obtained.

### (Lithium Transition Metal Composite Oxide)

The lithium transition metal composite oxide used in the invention is a layered rock salt type oxide, and is in a form of particles having a layered structure of a lithium layer (Li layer) and a transition metal-lithium layer (TM-Li layer).

### <Chemical Composition>

In a lithium transition metal composite oxide (for example, LiNi_{0.5}Mn_{0.5}O₂) in the related art, when Li is solid-soluted in a transition element, Ni²⁺ involved in an oxidation-reduction reaction is converted into Ni³⁺, and thus it is necessary to increase the amount of Ni used in order to improve electrochemical characteristics as a cathode active material. The invention is based on the finding that an increase in the valence of Ni ions to 3 can be suppressed by adding Ti as a constituent element to LiNi_{0.5}Mn_{0.5}O₂ and replacing a part of Ni_{0.5}Mn_{0.5} with Li and Ti. Thus, in the present invention, the amount of Ni used can be reduced while the electrochemical characteristics of the cathode active material are maintained in a satisfactory manner.

The lithium transition metal composite oxide used in the invention is expressed by General Formula (1): LiₘNiₓMn_{y}Ti_{z}O₂ (in the formula, m is in a range of 1.0<m≤1.1, x is in a range of 0.4≤x<0.5, y is in a range of 0.3<y<0.5, and z is in a range of 0<z≤0.133).

In the lithium transition metal composite oxide used in the invention, it is more preferable that in General Formula (1), m is in a range of 1.05≤m≤1.066, x is in a range of 0.4≤x≤0.475, y is in a range of 0.4≤y≤0.475, and z is in a range of 0.05≤z≤0.133. Specifically, the lithium transition metal composite oxide used in the present invention has a chemical composition in a range of Li_{1.05}Ni_{0.475}Mn_{0.475}Ti_{0.05}O₂ to Li_{1.066}Ni_{0.4}Mn_{0.4}Ti_{0.133}O₂. This represents that a molar ratio of Li/Ti in the transition metal-Li layer is in a range of Li:Ti=1:1 [Li(Li_{0.05}Ni_{0.475}Mn_{0.475}Ti_{0.05})O₂] to Li:Ti=1:2 [Li(Li_{0.066}Ni_{0.4}Mn_{0.4}Ti_{0.133})O₂].

The composition of the lithium transition metal composite oxide can be analyzed by inductively coupled plasma (ICP) optical emission spectrometry.

### <Lattice Constant>

The lithium transition metal composite oxide used in the invention is a layered compound of a rhombohedral crystal system, and has a crystal structure of a space group R-3m. With regard to the lattice constant of the lithium transition metal composite oxide, an a-axis length is preferably 2.886 Å to 2.900 Å, a c-axis length is preferably 14.29 Å to 14.35 Å, and c/a is preferably 4.940 to 4.960. When the lattice constant is within the above-described range, in the lithium transition metal composite oxide, lithium ions are likely to be diffused in primary particles, and resistance is low. The lattice constant of the crystal can be determined by a least square method by measuring an X-ray diffraction pattern of the lithium transition metal composite oxide and using each index and plane spacing thereof.

### <Spectrum of ⁶Li-MAS-NMR>

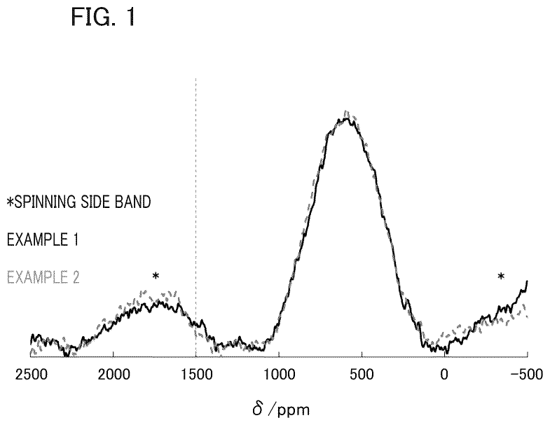

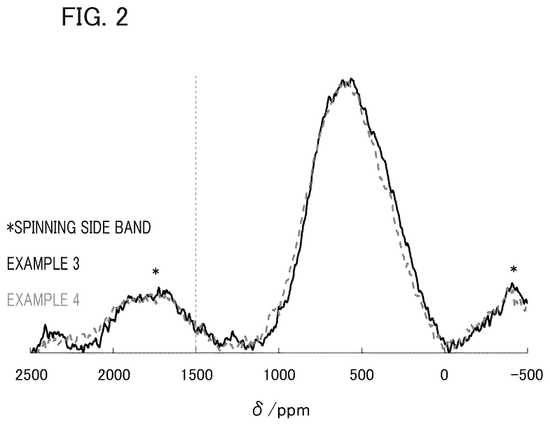

FIGS. 1 and 2 illustrate solid lithium nuclear magnetic resonance (⁶Li-MAS-NMR) spectra of the lithium transition metal composite oxide according to the embodiment of the invention. A solid line indicates a spectrum after a heat treatment at 1050° C. or 1100° C. for 5 minutes, and a broken line indicates a spectrum after the heat treatment at 1050° C. or 1100° C. for 5 minutes and further holding at 850° C. or 900° C. for 6 hours. In the spectra, a single peak without cracks (that is, no phase separation or domain formation) is observed near 600 ppm. This represents that Ni, Mn, and Ti (transition metals) are uniformly dispersed. When the transition metals are not uniformly dispersed and a Ni-rich domain or a Mn-rich domain is formed, a peak near 600 ppm is cracked and does not become a single peak.

In the spectra shown in FIGS. 1 and 2, there is no peak other than a spinning side band near 1500 ppm. When the Mn-rich domain is formed in the transition metal-Li layer, a peak appears near 1500 ppm.

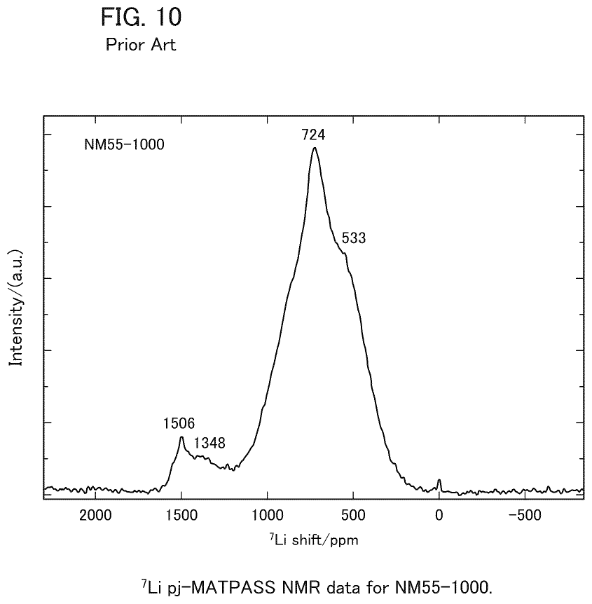

For example, in Mitsuharu Tabuchi, Riki Kataoka, and Koji Yazawa, “High-Capacity Li-excess lithium nickel manganese oxide as a Co-free positive electrode material”, Materials Research Bulletin, 137 (2021) 111178, a ⁷Li pj-MATPASS NMR spectrum of LiNi_{0.5}Mn_{0.5}O₂ shown in FIG. 10 is disclosed, a main peak of 724 ppm due to the Mn-rich domain and a shoulder peak of 533 ppm due to the Ni-rich domain are observed, and the peaks are not single peaks. This represents that the transition metal (Ni, Mn) is not uniformly dispersed in LiNi_{0.5}Mn_{0.5}O₂ disclosed in Mitsuharu Tabuchi, Riki Kataoka, and Koji Yazawa, “High-Capacity Li-excess lithium nickel manganese oxide as a Co-free positive electrode material”, Materials Research Bulletin, 137 (2021) 111178. In addition, a peak of 1506 ppm due to Mn—Li and a peak of 1348 ppm due to Ni and Mn—Li are observed near 1500 ppm, and this also represents that the transition metal is not uniformly dispersed.

The lithium transition metal composite oxide used in the invention has no peak at 1500 ppm in the ⁶Li-MAS-NMR spectrum after the heat treatment, or a peak intensity ratio of 1500 ppm/600 ppm is 0.15 or less, 0.1 or less, or 0.05 or less. Preferably, the lithium transition metal composite oxide used in the invention has no peak at 1500 ppm. In this specification, the absence of a peak at 1500 ppm represents that a peak other than a ghost peak such as a spinning side band does not exist at 1500 ppm. The present inventors have confirmed that there is no peak other than a ghost peak at 1500 ppm by peak separation in the ⁶Li-MAS-NMR spectra shown in FIGS. 1 and 2.

In the lithium transition metal composite oxide used in the invention, since the transition metal is uniformly dispersed, charge and discharge capacity can be increased when the lithium transition metal composite oxide is used in a lithium secondary battery as a cathode active material.

The ⁶Li-MAS-NMR spectra can be measured by a solid lithium nuclear magnetic resonance apparatus using a magic angle sample rotation method.

### <X-Ray Diffraction (XRD) Pattern>

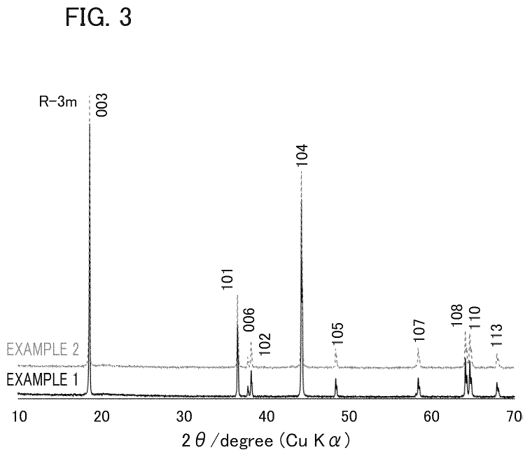

FIG. 3 illustrates an XRD pattern of the lithium transition metal composite oxide (Li_{1.05}Ni_{0.475}Mn_{0.475}Ti_{0.05}O₂) according to this embodiment. In a pattern (solid line) after a raw material mixture is heat-treated at 1050° C. for 5 minutes and a pattern (broken line) after the raw material mixture is heat-treated at 1050° C. for 5 minutes and is further held at 850° C. for 6 hours, no peak due to the domain structure is observed. In particular, the two peaks at 2θ=108° and 110° are clearly separated in both patterns, and this represents that Ni, Mn, and Ti are uniformly dispersed without phase separation.

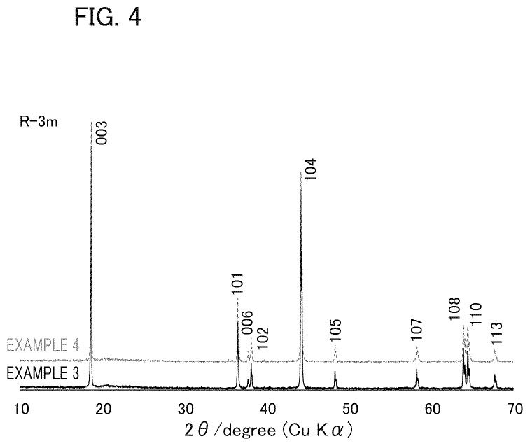

FIG. 4 illustrates an XRD pattern of a lithium transition metal composite oxide (Li_{1.066}Ni_{0.4}Mn_{0.4}Ti_{0.133}O₂) according to another embodiment. In a pattern (solid line) after a raw material mixture is heat-treated at 1100° C. for 5 minutes and a pattern (broken line) after the raw material mixture is heat-treated at 1100° C. for 5 minutes and is further held at 900° C. for 6 hours, no peak due to the domain structure is observed. In particular, the two peaks at 2θ=108° and 110° are clearly separated in both patterns, and this represents that Ni, Mn, and Ti are uniformly dispersed without phase separation.

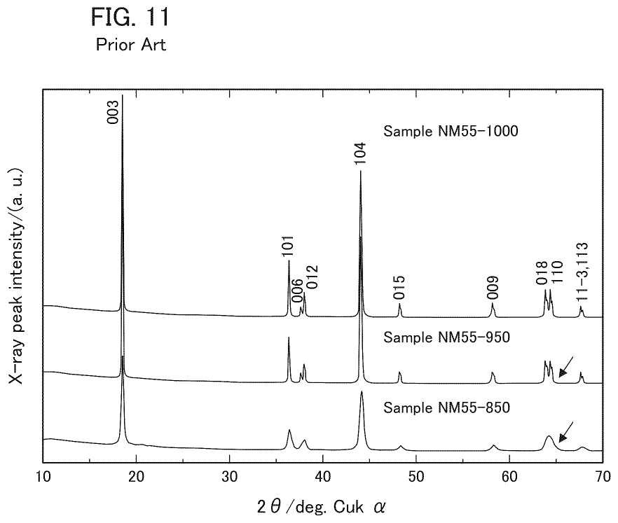

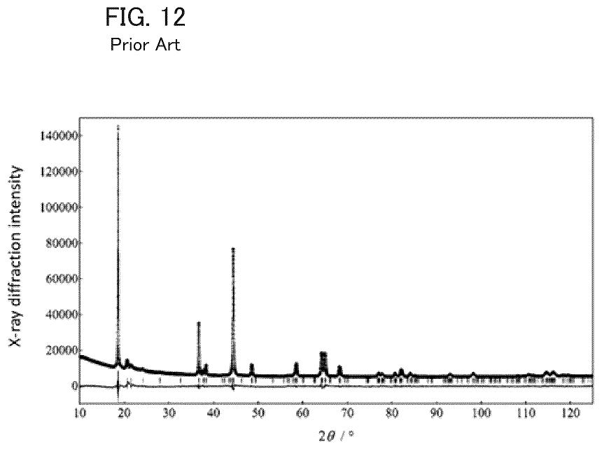

On the contrary, for example, Mitsuharu Tabuchi, Riki Kataoka, and Koji Yazawa, “High-Capacity Li-excess lithium nickel manganese oxide as a Co-free positive electrode material”, Materials Research Bulletin, 137 (2021) 111178 discloses an XRD pattern of LiNi_{0.5}Mn_{0.5}O₂, and as shown in FIG. 11, a peak at 2θ=65° is not clearly separated or tailed. In Mitsuharu Tabuchi, Riki Kataoka, and Koji Yazawa, “High-Capacity Li-excess lithium nickel manganese oxide as a Co-free positive electrode material”, Materials Research Bulletin, 137 (2021) 111178, the XRD pattern implies that the disclosed lithium nickel manganese oxide has two phases. In the XRD pattern disclosed in JP 2022-60167 A, as illustrated in FIG. 12, a peak due to the Li₂MnO₃ domain structure is observed near 2θ=20°.

### <Surface Composition>

Particles of the lithium transition metal composite oxide may be primary particles or secondary particles, but are preferably secondary particles in which a plurality of primary particles are aggregated with each other because relatively dense particles are obtained.

The particles of the lithium transition metal composite oxide have a multilayer structure including a lithium layer and a transition metal-Li layer, and a composition of an outer surface preferably has a higher content ratio of Mn in comparison to a composition of a central portion. In the lithium transition metal composite oxide used in the invention, a ratio (Mn/Ni ratio) of the number of atoms of Mn to the number of atoms of Ni on the surface of the lithium transition metal composite oxide is preferably more than 1.0 and less than 2.5, and more preferably more than 1.0 and less than 2.0. When the Mn/Ni ratio is within the above-described range, movement of lithium ions is not inhibited, and the charge and discharge capacity of the lithium secondary battery becomes high in a case of being used as a cathode active material.

A composition of a manganese-rich surface can be determined, for example, by quantitative analysis of X-ray photoelectron spectroscopy (XPS). According to the XPS, the composition of the manganese-rich surface in entire particles can be analyzed. That is, an analysis result obtained by the XPS does not indicate a local composition of the entire surface of one particle, and indicates a composition of the entire surface of the particle.

### [Method for Manufacturing Cathode Active Material for Lithium Secondary Battery]

The cathode active material for the lithium secondary battery of the invention contains the above-described lithium transition metal composite oxide as a main component. As a lithium source of the lithium transition metal composite oxide, it is possible to use a known compound such as a hydroxide such as lithium hydroxide monohydrate (LiOH·H₂O), a carbonate such as lithium carbonate (Li₂CO₃), or an acetate such as lithium acetate (CH₃COOLi) and lithium acetate dihydrate (CH₃COOLi·2H₂O), and there is no particular limitation. In compounds of a nickel source, a manganese source, and a titanium source of the transition metal, known oxides, hydroxides, or metal salts of nickel, manganese, and titanium can be widely used, and are not particularly limited. As the nickel compound, nickel hydroxide (Ni(OH)₂), nickel (II) chloride (NiCl₂), nickel (II) chloride hexahydrate (NiCl₂·6H₂O), and nickel (II) nitrate hexahydrate (Ni(NO₃)₂·6H₂O) can be used, but the nickel compound is not limited thereto. As the manganese compound, manganese (II) chloride (MnCl₂), manganese (II) chloride tetrahydrate (MnCl₂·4H₂O), manganese carbonate hexahydrate (MnCO₃·6H₂O), manganese (II) nitrate hexahydrate (Mn(NO₃)₂·6H₂O) and the like can be used, but the manganese compound is not limited thereto. As the titanium compound, titanium dioxide (TiO₂), titanium (IV) sulfate (Ti(SO₄)₂), and the like can be used, but the titanium compound is no limitation thereto. The transition metal compounds can be used alone and as a composite hydroxide (for example, nickel-manganese-titanium complex hydroxide) or the like by using a coprecipitation method or the like.

The lithium transition metal composite oxide used in the invention can be synthesized by using a known method. For example, a composite hydroxide or a composite oxide of a nickel compound and a manganese compound is prepared as an intermediate compound, the intermediate compound, a titanium compound, and a lithium compound are mixed to obtain a raw material mixture, and the raw material mixture is heat-treated (for example, fired) at a predetermined temperature for a predetermined time in a predetermined atmosphere, whereby synthesis can be performed. In addition, a composite hydroxide or a composite oxide of a nickel compound, a manganese compound, and a titanium compound is prepared as an intermediate compound, the intermediate compound and a lithium compound are mixed to obtain a raw material mixture, and the raw material mixture is heat-treated (for example, fired) at a predetermined temperature for a predetermined time in a predetermined atmosphere, whereby synthesis can also be performed.

It is preferable that the lithium transition metal composite oxide obtained in the heat treatment process (the heat-treating) is further held in a predetermined temperature range for a predetermined time by a slow cooling process. Since slow cooling conditions vary depending on treatment conditions (for example, a heat treatment atmosphere such as an oxygen atmosphere, a nitrogen atmosphere, and a vacuum atmosphere) and the like, it is preferable to appropriately adjust the slow cooling conditions. The present inventors have found that the transition metal of the lithium transition metal composite oxide is uniformly dispersed, and the Mn/Ni ratio on the particle surface can be increased by appropriately selecting the heat treatment (the heat-treating) conditions and the slow cooling conditions. Hereinafter, a method for manufacturing a cathode active material for a lithium secondary battery of the invention will be described in more detail with reference to an embodiment.

### (First Process)

In a first process, first, a predetermined amount of titanium compound and a predetermined amount of lithium compound are added to a nickel-manganese compound as an intermediate, and the mixture is dispersed and mixed in a solvent such as ethanol. Note that, a predetermined amount of intermediate compound, a predetermined amount of titanium compound, and a predetermined amount of lithium compound may be mixed not only by wet mixing using a solvent but also by dry mixing not using a solvent. For example, in a case of synthesizing Li_{1.05}Ni_{0.475}Mn_{0.475}Ti_{0.05}O₂ by using titanium dioxide (TiO₂) as a titanium compound and lithium carbonate (Li₂CO₃) as a lithium compound, Li₂CO₃ is preferably weighed more than the stoichiometric ratio by 1% by mass to 5% by mass, for example, 2% by mass. Similarly, in a case of synthesizing Li_{1.066}Ni_{0.4}Mn_{0.4}Ti_{0.133}O₂, Li₂CO₃ is preferably weighed more than the stoichiometric ratio by 1% by mass to 5% by mass, for example, 2% by mass.

The nickel-manganese compound can be synthesized by a known method. In a case where the nickel-manganese compound is a hydroxide, for example, nickel sulfate hexahydrate (NiSO₄·6H₂O) and manganese sulfate pentahydrate (MnSO₄·5H₂O) are weighed so that a molar ratio of Ni:Mn becomes 1:1, pure water is added thereto to dissolve the compounds, and an aqueous alkali solution is added dropwise to the aqueous sulfate solution to coprecipitate the compounds as a nickel-manganese composite hydroxide.

As the intermediate compound, a nickel-manganese-titanium compound may be used instead of the nickel-manganese compound. For example, a predetermined amount of lithium compound is added to the nickel-manganese-titanium compound, and the mixture is dispersed and mixed in a solvent such as ethanol. Note that, a predetermined amount of nickel-manganese-titanium compound, and a predetermined amount of lithium compound may be mixed not only by wet mixing using a solvent but also by dry mixing not using a solvent. For example, in a case of synthesizing Li_{1.05}Ni_{0.475}Mn_{0.475}Ti_{0.05}O₂ by using lithium carbonate (Li₂CO₃) as a lithium compound, Li₂CO₃ is weighed preferably more than the stoichiometric ratio by 1% by mass to 5% by mass, for example, 2% by mass. Similarly, in a case of synthesizing Li_{1.066}Ni_{0.4}Mn_{0.4}Ti_{0.133}O₂, Li₂CO₃ is preferably weighed more than the stoichiometric ratio by 1% by mass to 5% by mass, for example, 2% by mass.

The nickel-manganese-titanium compound can be synthesized using a known method. In a case where the nickel-manganese-titanium compound is a hydroxide, for example, nickel sulfate hexahydrate (NiSO₄·6H₂O), manganese sulfate pentahydrate (MnSO₄·5H₂O), and titanium sulfate (Ti(SO₄)₂) are weighed so that the molar ratio of Ni:Mn Ti becomes 1:1:x (x is preferably 0.05 to 0.333), pure water is added thereto to dissolve the compounds, an aqueous alkali solution is added dropwise to the aqueous sulfate solution, and the compounds can be coprecipitated as a nickel-manganese-titanium composite hydroxide.

As a precursor, a mixture of a lithium compound, a titanium compound, and a nickel-manganese compound, or a mixture of a lithium compound and a nickel-manganese-titanium compound is pulverized and mixed to a preferable size, and the mixture is filled in a crucible and is heat-treated. As the crucible, an alumina sagger, an alumina crucible, a platinum crucible, a gold crucible, or the like is used. In the heat treatment of the mixture, for example, a firing furnace or a roller hearth kiln is used.

The mixture put into the sagger or the crucible is heated to reach a heat treatment temperature at a temperature-rising rate of 5° C./min to 25° C./min, and preferably 10° C./min to 25° C./min. A heat treatment atmosphere is not particularly limited, and examples thereof include an atmosphere (under an air atmosphere), an oxygen flow, and the like. The heat treatment atmosphere is preferably the oxygen flow. A heat treatment time can be appropriately set in correspondence with the heat treatment temperature. The heat treatment time represents time for holding the heat treatment temperature.

In a case where a mixture of the lithium compound (for example, Li₂CO₃), the titanium compound (for example, TiO₂), and the nickel-manganese compound is heat-treated, the heat treatment temperature is preferably 1000° C. to 1200° C., and more preferably 1000° C. to 1100° C. The heat treatment time is preferably 1 minute to 7 hours, more preferably 2 minutes to 6 hours, and still more preferably 3 minutes to 5 hours.

In a case where the mixture of the lithium compound (for example, Li₂CO₃) and the nickel-manganese-titanium compound is heat-treated, the heat treatment temperature is preferably 1000° C. to 1200° C., and more preferably 1000° C. to 1100° C. The heat treatment time is preferably 1 minute to 7 hours, more preferably 2 minutes to 6 hours, and still more preferably 3 minutes to 5 hours.

### (Second Process)

In a second process, a powder obtained after the heat treatment in the first process is cooled so as to reach 900° C. at a temperature-falling rate of 5° C./min to 25° C./min, and preferably 10° C./min to 25° C./min, and then the powder is held at 900° C. for 0.5 hours to 12 hours. The atmosphere for holding the powder at 900° C. is not particularly limited, and examples thereof include the atmosphere (under an air atmosphere), a nitrogen atmosphere, and an oxygen flow.

The method for manufacturing the cathode active material for the lithium secondary battery of the invention may include a process of holding the powder at 850° C. for 12 hours after the second process. Even in this case, the powder held at 900° C. in the second process is cooled to reach 850° C. at a temperature-falling rate of 10° C./min, and then the powder is held at 850° C. for 12 hours. The atmosphere for holding the powder at 850° C. is not particularly limited, and examples thereof include the atmosphere (under an air atmosphere), a nitrogen atmosphere, and an oxygen flow.

### (Third Process)

In a third process, the powder held at 900° C. in the second process is cooled so as to reach 800° C. at a temperature-falling rate of 5° C./min to 25° C./min, and preferably 10° C./min to 25° C./min, and then the powder is held at 800° C. for 0.5 hours to 12 hours. The atmosphere for holding the powder at 800° C. is not particularly limited, and examples thereof include the atmosphere (under an air atmosphere), a nitrogen atmosphere, and an oxygen flow.

### (Fourth Process)

In a fourth process, the powder held at 800° C. in the third process is cooled so as to reach 750° C. at a temperature-falling rate of 5° C./min to 25° C./min, and preferably 10° C./min to 25° C./min, and then the powder is held at 750° C. for 0.5 hours to 12 hours. The atmosphere for holding the powder at 750° C. is not particularly limited, and examples thereof include the atmosphere (under an air atmosphere), a nitrogen atmosphere, and an oxygen flow.

### (Fifth Process)

In a fifth process, the powder held at 750° C. in the fourth process is cooled so as to reach 600° C. at a temperature-falling rate of 5° C./min to 25° C./min, and preferably 10° C./min to 25° C./min, and then the powder is held at 600° C. for 0.5 hours to 20 hours. The atmosphere for holding the powder at 600° C. is not particularly limited, and examples thereof include the atmosphere (under an air atmosphere), a nitrogen atmosphere, and an oxygen flow.

### (Sixth Process)

In a sixth process, the powder held at 600° C. in the fifth process is cooled so as to reach 400° C. to 500° C. at a temperature-falling rate of 10° C./min, and then the powder is held at 400° C. to 500° C. for 0.5 hours to 30 hours. The sixth process may be a process of holding the powder at 450° C. for 30 hours and then holding the powder at 400° C. for 30 hours. In addition, the sixth process may be a process of holding the powder at 500° C. for 20 hours.

The slow cooling processes from the second process to the sixth process described above can be appropriately changed or omitted as necessary. In one embodiment, the slow cooling process is held at preferably 850° C. to 950° C., preferably 3 hours to 12 hours, more preferably 4 hours to 8 hours, and most preferably 6 hours after the heat treatment. The cathode active material for the lithium secondary battery of the invention can increase the Mn/Ni ratio on the particle surface of the lithium transition metal composite oxide by appropriately selecting the cooling conditions.

### [Lithium Secondary Battery]

The lithium secondary battery of the invention is a lithium secondary battery including a cathode, an anode, an electrolyte, and other battery elements as necessary, and the cathode contains a cathode active material containing the lithium transition metal composite oxide of the above-described embodiment as a main component.

In the lithium secondary battery of the invention, a known battery element of the lithium secondary battery can be employed as it is except that the cathode contains a cathode active material containing the above-described lithium transition metal composite oxide as a main component. The lithium secondary battery of the invention may have any of a coin type, a button type, a cylindrical type, a square type, and a laminate type. In addition, the lithium secondary battery of the invention is applicable to a wide range of applications such as mobile devices including mobile phones and notebook computers, and in-vehicle applications.

Hereinafter, as an embodiment of the lithium secondary battery of the invention, a lithium secondary battery (coin-type lithium secondary battery) using an electrolytic solution will be described. Each battery element described below can be similarly applied to an all-solid-state lithium secondary battery not using an electrolytic solution.

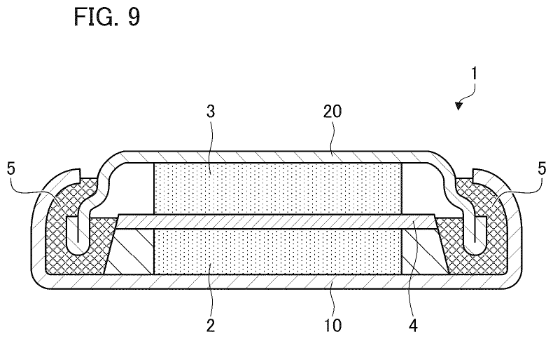

FIG. 9 is a cross-sectional view schematically illustrating an example of a lithium secondary battery of this embodiment. FIG. 9 illustrates an example in which the lithium secondary battery of this embodiment is a coin-type lithium secondary battery. A lithium secondary battery 1 illustrated in FIG. 9 includes an anode can (anode terminal) 20, an anode 3, a separator 4 impregnated with an electrolytic solution, an insulating packing (gasket) 5, a cathode 2, and a cathode can 10.

As illustrated in FIG. 9, the cathode can 10 is disposed on a lower side, the anode can 20 is disposed on an upper side, and an outer shape of the lithium secondary battery 1 is formed by the cathode can 10 and the anode can 20. The cathode 2 and the anode 3 are provided between the cathode can 10 and the anode terminal 20 with the separator 4 impregnated with an electrolytic solution interposed therebetween, and the cathode 2 and the anode 3 are separated from each other by the separator 4. The cathode can 10 and the anode can 20 are electrically insulated from each other by the insulating packing 5.

In the lithium secondary battery of this embodiment, a cathode mixture is prepared by blending a conductive agent, a binder, and the like with the cathode active material for the lithium secondary battery of this embodiment as necessary, and a cathode can be manufactured by pressing the cathode mixture to a current collector (not shown). As the current collector, a stainless steel mesh, an aluminum foil, or the like can be preferably used. As the conductive agent, acetylene black, ketjen black, or the like can be preferably used. As the binder, tetrafluoroethylene, polyvinylidene fluoride, or the like can be preferably used.

Blending of the cathode active material, the conductive agent, and the binder in the cathode mixture is not particularly limited. The content of the conductive agent in the cathode mixture is preferably 1% by mass to 15% by mass, and more preferably 0.1% by mass to 5% by mass. The content of the conductive agent in the cathode mixture is preferably 0.1% by mass to 10% by mass, and more preferably 0.1% by mass to 5% by mass. It is preferable to blend the cathode active material, the conductive agent, and the binder such that the remainder (a portion other than the cathode active material and the conductive agent) in the cathode mixture becomes the cathode active material.

In the lithium secondary battery of this embodiment, as a counter electrode with respect to the cathode, a known electrode, for example, a metal-based material such as metallic lithium and a lithium alloy, a carbon-based material such as graphite and mesocarbon microbeads (MCMB), and a silicon-based material such as Si, a Si alloy, and silicon oxide, which functions as an anode active material and is capable of intercalating and deintercalating lithium, can be employed.

Known battery elements can be employed as the separator, the battery container, and the like.

As the electrolyte, a known electrolytic solution, a known solid electrolyte, or the like can be employed. As the electrolytic solution, for example, a solution obtained by dissolving an electrolyte such as lithium perchlorate or lithium hexafluorophosphate in a solvent such as ethylene carbonate (EC), dimethyl carbonate (DMC), propylene carbonate (PC), or diethyl carbonate (DEC) can be used.

In addition, the all-solid-state lithium secondary battery can have a similar structure as in a known all-solid-state lithium secondary battery except that a cathode active material containing the above-described lithium transition metal composite oxide as a main component is used.

In the case of the all-solid-state lithium secondary battery, as the electrolyte, for example, solid electrolytes such as a polymer-based solid electrolyte such as a polyethylene oxide-based polymer compound and a polymer compound including at least one or more of a polyorganosiloxane chain and a polyoxyalkylene chain, a sulfide-based solid electrolyte, and an oxide-based solid electrolyte can be used.

For the cathode of the all-solid-state lithium secondary battery, for example, a cathode mixture containing a solid electrolyte in addition to the cathode active material, the conductive agent, and the binder can be carried to a cathode current collector such as aluminum, nickel, and stainless steel.

In the lithium secondary battery of this embodiment, since the cathode contains a cathode active material containing the above-described lithium transition metal composite oxide as a main component, high capacity is realized.

### EXAMPLES

Next, examples of the invention will be described, but the invention is not limited to these examples.

### Example 1

### Synthesis of Lithium-Nickel-Manganese-Titanium Oxide: Li_{1.05}Ni_{0.45}Mn_{0.45}Ti_{0.05}O₂

Li₂CO₃ (manufactured by Kojundo Chemical Lab. Co., Ltd.), and Ni_{0.5}Mn_{0.5}(OH)₂ and TiO₂ (manufactured by Kojundo Chemical Lab. Co., Ltd.) were weighed so that a ratio of Li:Ni:Mn:Ti becomes 1.05:0.45:0.45:0.05 in terms of a molar ratio, and in consideration of Li evaporation, Li₂CO₃ was weighed to be rich by 2% by mass based on the stoichiometric ratio. The total mass of Li₂CO₃ (manufactured by Kojundo Chemical Lab. Co., Ltd.), and Ni_{0.5}Mn_{0.5}(OH)₂ and TiO₂ (manufactured by Kojundo Chemical Lab. Co., Ltd.) was set to 2.1 g. The materials were dispersed and mixed in ethanol by a mortar. Thereafter, the resulting mixture was filled in a JIS standard platinum crucible. The mixture filled in the platinum crucible in the air was heated at a temperature-rising rate of 15° C./min and fired at 1050° C. for 5 minutes by using a firing furnace to obtain a lithium-nickel-manganese-titanium oxide of Example 1.

### (Analysis)

A chemical composition of an obtained sample was analyzed by an ICP optical emission spectrometer (trade name: Agilent 5110 VDV, manufactured by Agilent Technologies), and the results are shown in Table 1. As shown in Table 1, it was confirmed that Li:Ni:Mn:Ti=1.05:0.44:0.46:0.05.

In addition, an X-ray diffraction pattern of the obtained sample was measured with a powder X-ray diffractometer (trade name: SmartLab, manufactured by Rigaku Corporation), and a lattice constant was determined by the least square method using each index and plane spacing. When a space group of the obtained sample was set to R-3m, and the lattice constant was determined, a was 2.88758 (7) Å, c was 14.3078 (5) Å, and c/a was 4.9549. The powder X-ray diffraction pattern is shown in FIG. 3. The lattice constants are shown in Table 1.

In addition, the results obtained by analyzing the composition of the surface layer of the obtained sample by quantitative analysis with an X-ray photoelectron spectroscopy (XPS) analyzer (trade name: K-Alpha⁺, manufactured by Thermo Fisher Scientific) are shown in Table 1. As shown in Table 1, a Mn/Ni ratio in the surface layer was 1.20.

### Example 2

### Synthesis of Lithium-Nickel-Manganese-Titanium Oxide: Li_{1.05}Ni_{0.45}Mn_{0.45}Ti_{0.05}O₂

Li₂CO₃ (manufactured by Kojundo Chemical Lab. Co., Ltd.), and Ni_{0.5}Mn_{0.5}(OH)₂ and TiO₂ (manufactured by Kojundo Chemical Lab. Co., Ltd.) were weighed so that a ratio of Li:Ni:Mn:Ti becomes 1.05:0.45:0.45:0.05 in terms of a molar ratio, and in consideration of Li evaporation, Li₂CO₃ was weighed to be rich by 2% by mass based on the stoichiometric ratio. The total mass of Li₂CO₃ (manufactured by Kojundo Chemical Lab. Co., Ltd.), and Ni_{0.5}Mn_{0.5}(OH)₂ and TiO₂ (manufactured by Kojundo Chemical Lab. Co., Ltd.) was set to 2.1 g. The materials were dispersed and mixed in ethanol by a mortar. Thereafter, the resulting mixture was filled in a JIS standard platinum crucible. The mixture filled in the platinum crucible in the air was heated at a temperature-rising rate of 15° C./min and fired at 1050° C. for 5 minutes by using a firing furnace to obtain a lithium-nickel-manganese-titanium oxide of Example 1.

The powder after the heat treatment was cooled so as to reach 850° C. at a temperature-falling rate of 10° C./min, and then the powder was held at 850° C. for 6 hours in the air.

Thereafter, a lithium-nickel-manganese-titanium oxide of Example 2 was obtained by leaving the powder as is until the temperature of the powder reached room temperature.

### (Analysis)

The chemical composition of the obtained sample was analyzed in a similar manner as in Example 1. The results are shown in Table 1. As shown in Table 1, it was confirmed that Li:Ni:Mn:Ti was 1.09:0.44:0.42:0.05. In the chemical composition, Mn is reduced as compared with Example 1 because Mn moves to the surface layer of the sample obtained by the heat treatment and further reaches the platinum crucible. The reason why Li is increased as compared with Example 1 is because calculation was performed on the assumption that the phase sum of the chemical composition was set to 2 and thus the decrease in Mn was allocated to Li. The decrease in Mn depends on the amount of a precursor filled in the crucible.

In addition, the space group of the obtained sample was set to R-3m, and it was confirmed that the phase is a single phase in which all peaks can be indexed. When lattice constants were further determined, a was 2.88675 (7) Å, c was 14.3067 (8) Å, and c/a was 4.9560. The powder X-ray diffraction pattern is shown in FIG. 3. The lattice constants are shown in Table 1.

In addition, the results obtained by analyzing the composition of the surface layer of the obtained sample are shown in Table 1. As shown in Table 1, the Mn/Ni ratio in the surface layer was 1.47.

### [Preparation of Lithium Secondary Battery]

The lithium-nickel-manganese-titanium oxide of Example 1 or the lithium-nickel-manganese-titanium oxide of Example 2 as a cathode active material, acetylene black (AB) as a conductive agent, and polyvinylidene fluoride (PVDF) as a binder were blended in a weight ratio of 8:1:1 by using N-methyl-2 pyrrolidone (NMP) as a solvent to prepare slurry. Thereafter, aluminum foil having a thickness of 15 μm was coated with the slurry and was dried to prepare a cathode having a diameter of 14ϕ. A coating area density was set to 4.5 mg/cm², and a volume density was set to 2.3 g/cm³. With respect to the cathode, a lithium metal having a thickness of 200 μm and a diameter of 16ϕ was used as a counter electrode, and a polyethylene microporous film having a thickness of 20 μm and a diameter of 18ϕ was used as a separator. An electrolytic solution was set to a 1.2 mol/L solution obtained by dissolving lithium hexafluorophosphate (LiPF₆) in a mixed solvent of ethylene carbonate (EC), dimethyl carbonate (DMC), and ethyl methyl carbonate (EMC) (volume ratio: 3:4:3), and a lithium secondary battery (2032 coin type cell) having the structure illustrated in FIG. 9 was prepared. The battery was manufactured in accordance with a known cell configuration and assembly method.

### [Charge and Discharge Test]

With regard to the prepared lithium secondary battery, a charge and discharge test was conducted at a constant current at a rate of 0.05 C, a current density of 12.5 mA/g, and a cutoff potential of 4.7 V to 2.5 V under a temperature condition of 55° C. to evaluate charge and discharge characteristics. The charge and discharge test was initiated from charging.

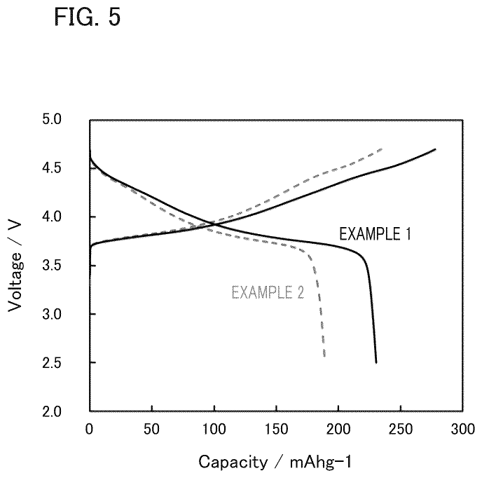

FIG. 5 illustrates charge and discharge curves in Example 1 and Example 2. FIG. 5 illustrates a voltage change at the time of discharge in which a cell voltage decreases as capacity increases, and a voltage change at the time of charge in which the cell voltage increases as the capacity increases.

As illustrated in FIG. 5, it could be understood that the lithium secondary battery using the lithium-nickel-manganese-titanium oxide of Example 1 as a cathode active material had higher capacity in comparison to the lithium secondary battery using the lithium-nickel-manganese-titanium oxide of Example 2 as a cathode active material. Even in Example 2, if the heat treatment conditions are appropriately performed, the capacity becomes higher in comparison to Example 1.

Further, the obtained samples of Examples 1 and 2 were analyzed by Li-MAS-NMR (trade name: AVANCE 300, manufactured by Bruker Corporation). The results are shown in FIG. 1. From the results shown in FIG. 1, there was no peak at 1495 ppm to 1505 ppm in the spectrum of ⁶Li-MAS-NMR.

TABLE 1

| | | | | | Sur- |
|---|---|---|---|---|---|
| | | | | | face |
| | | | | | Mn/Ni |
| | Li:Ni:Mn:Ti | | | | ratio |
| | (ICP) | a/Å | c/Å | c/a | (XPS) |
| Example 1 | 1.05:0.44:0.46:0.05 | 2.88758(7) | 14.3078(5) | 4.9549 | 1.20 |
| Example 2 | 1.09:0.44:0.42:0.05 | 2.88675(7) | 14.3067(8) | 4.9560 | 1.47 |

### Example 3

### Synthesis of Lithium-Nickel-Manganese-Titanium Oxide: Li_{1.07}Ni_{0.40}Mn_{0.40}Ti_{0.13}O₂

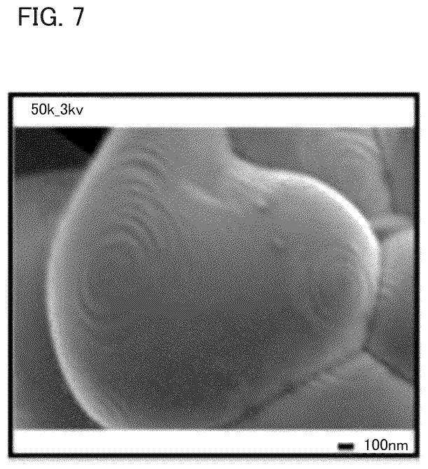

Li₂CO₃ (manufactured by Kojundo Chemical Lab. Co., Ltd.), and Ni_{0.5}Mn_{0.5}(OH)₂ and TiO₂ (manufactured by Kojundo Chemical Lab. Co., Ltd.) were weighed so that a ratio of Li:Ni:Mn:Ti becomes 1.066:0.40:0.40:0.133 in terms of a molar ratio, and in consideration of Li evaporation, Li₂CO₃ was weighed to be rich by 2% by mass based on the stoichiometric ratio. The total mass of Li₂CO₃ (manufactured by Kojundo Chemical Lab. Co., Ltd.), and Ni_{0.5}Mn_{0.5}(OH)₂ and TiO₂ (manufactured by Kojundo Chemical Lab. Co., Ltd.) was set to 2.1 g. The materials were dispersed and mixed in ethanol by a mortar. Thereafter, the resulting mixture was filled in a JIS standard platinum crucible. The mixture filled in the platinum crucible in the air was heated at a temperature-rising rate of 15° C./min and fired at 1100° C. for 5 minutes by using a firing furnace to obtain a lithium-nickel-manganese-titanium oxide of Example 3. An electron micrograph of the obtained lithium-nickel-manganese-titanium oxide is shown in FIG. 7.

### (Analysis)

Results obtained by analyzing the chemical composition of the obtained sample in a similar manner as in Example 1 are shown in Table 2. As shown in Table 2, it was confirmed that Li:Ni:Mn:Ti was 1.09:0.40:0.38:0.13. In the chemical composition, Mn is reduced as compared with a charged composition because Mn moves to the surface layer of the sample obtained by the heat treatment and further reaches the platinum crucible. The reason why Li is increased as compared with Example 1 is because calculation was performed on the assumption that the phase sum of the chemical composition was set to 2 and thus the decrease in Mn was allocated to Li. The decrease in Mn depends on the amount of a precursor filled in the crucible.

In addition, the space group of the obtained sample was set to R-3m, and it was confirmed that the phase is a single phase in which all peaks can be indexed. When lattice constants were further determined, a was 2.89293 (12) Å, c was 14.3323 (7) Å, and c/a was 4.9543. The powder X-ray diffraction pattern is shown in FIG. 4. The lattice constants are shown in Table 2.

In addition, the results obtained by analyzing the composition of the surface layer of the obtained sample are shown in Table 2. As shown in Table 2, the Mn/Ni ratio in the surface layer was 1.06.

### Example 4

### Synthesis of Lithium-Nickel-Manganese-Titanium Oxide: Li_{1.07}Ni_{0.40}Mn_{0.40}Ti_{0.13}O₂

Li₂CO₃ (manufactured by Kojundo Chemical Lab. Co., Ltd.), and Ni_{0.5}Mn_{0.5}(OH)₂ and TiO₂ (manufactured by Kojundo Chemical Lab. Co., Ltd.) were weighed so that a ratio of Li:Ni:Mn:Ti becomes 1.066:0.40:0.40:0.133 in terms of a molar ratio, and in consideration of Li evaporation, Li₂CO₃ was weighed to be rich by 2% by mass based on the stoichiometric ratio. The total mass of Li₂CO₃ (manufactured by Kojundo Chemical Lab. Co., Ltd.), and Ni_{0.5}Mn_{0.5}(OH)₂ and TiO₂ (manufactured by Kojundo Chemical Lab. Co., Ltd.) was set to 2.1 g. The materials were dispersed and mixed in ethanol by a mortar. Thereafter, the resulting mixture was filled in a JIS standard platinum crucible. The mixture filled in the platinum crucible in the air was heated at a temperature-rising rate of 15° C./min and fired at 1100° C. for 5 minutes by using a firing furnace to obtain a lithium-nickel-manganese-titanium oxide of Example 3.

The powder after the heat treatment was cooled so as to reach 900° C. at a temperature-falling rate of 10° C./min, and then the powder was held at 900° C. for 6 hours or shorter in the air.

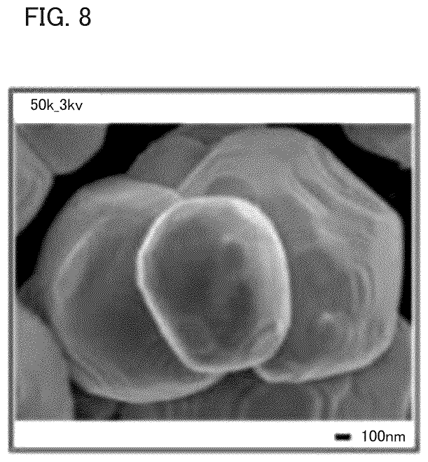

Thereafter, a lithium-nickel-manganese-titanium oxide of Example 4 was obtained by leaving the powder as is until the temperature of the powder reached room temperature. An electron micrograph of the obtained lithium-nickel-manganese-titanium oxide is shown in FIG. 8. When comparing FIGS. 7 and 8 with each other, it was confirmed that a surface morphology was changed by the slow cooling process.

### (Analysis)

Results obtained by analyzing the chemical composition of the obtained sample in a similar manner as in Example 3 are shown in Table 2. As shown in Table 2, it was confirmed that Li:Ni:Mn:Ti was 1.09:0.40:0.38:0.13. In the chemical composition, Mn is reduced as compared with a charged composition because Mn moves to the surface layer of the sample obtained by the heat treatment and further reaches the platinum crucible. The reason why Li is increased as compared with Example 1 is because calculation was performed on the assumption that the phase sum of the chemical composition was set to 2 and thus the decrease in Mn was allocated to Li. The decrease in Mn depends on the amount of a precursor filled in the crucible.

In addition, the space group of the obtained sample was set to R-3m in a similar manner as in Example 3, and it was confirmed that the phase is a single phase in which all peaks can be indexed. When lattice constants were further determined, a was 2.89424 (8) Å, c was 14.3366 (6) Å, and c/a was 4.9535. An X-ray diffraction pattern is shown in FIG. 4. The lattice constants are shown in Table 2.

In addition, results obtained by analyzing the composition of the surface layer of the obtained sample in a similar manner as in Example 3 are shown in Table 2. As shown in Table 2, the Mn/Ni ratio in the surface layer was 1.08.

### [Preparation of Lithium Secondary Battery]

The lithium-nickel-manganese-titanium oxide of Example 3 or the lithium-nickel-manganese-titanium oxide of Example 4 as a cathode active material, acetylene black (AB) as a conductive agent, and polyvinylidene fluoride (PVDF) as a binder were blended in a weight ratio of 8:1:1 by using N-methyl-2 pyrrolidone (NMP) as a solvent to prepare slurry. Thereafter, aluminum foil having a thickness of 15 μm was coated with the slurry and was dried to prepare a cathode having a diameter of 14ϕ. A coating area density was set to 4.5 mg/cm², and a volume density was set to 2.3 g/cm³. With respect to the cathode, a lithium metal having a thickness of 200 μm and a diameter of 16ϕ was used as a counter electrode, and a polyethylene microporous film having a thickness of 20 μm and a diameter of 18ϕ was used as a separator. An electrolytic solution was set to a 1.2 mol/L solution obtained by dissolving lithium hexafluorophosphate (LiPF₆) in a mixed solvent of ethylene carbonate (EC), dimethyl carbonate (DMC), and ethyl methyl carbonate (EMC) (volume ratio: 3:4:3), and a lithium secondary battery (2032 coin type cell) having the structure illustrated in FIG. 9 was prepared. The battery was manufactured in accordance with a known cell configuration and assembly method.

### [Charge and Discharge Test]

With regard to the prepared lithium secondary battery, a charge and discharge test was conducted at a constant current at a rate of 0.05 C, a current density of 12.5 mA/g, and a cutoff potential of 4.7 V to 2.5 V under a temperature condition of 55° C. to evaluate charge and discharge characteristics. The charge and discharge test was initiated from charging.

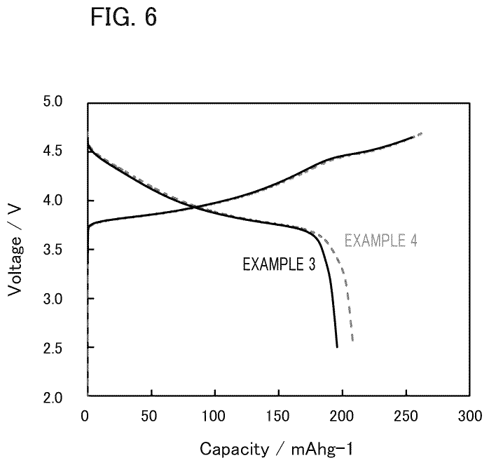

FIG. 6 illustrates charge and discharge curves in Example 3 and Example 4. FIG. 6 illustrates a voltage change at the time of discharge in which a cell voltage decreases as capacity increases, and a voltage change at the time of charge in which the cell voltage increases as the capacity increases.

As illustrated in FIG. 6, it could be understood that the lithium secondary battery using the lithium-nickel-manganese-titanium oxide of Example 4 as a cathode active material had higher capacity in comparison to the lithium secondary battery using the lithium-nickel-manganese-titanium oxide of Example 3 as a cathode active material. From the results shown in FIG. 6, it was confirmed that the lithium-nickel-manganese-titanium oxide of Example 4 can increase the capacity of the lithium secondary battery.

Further, the obtained samples were analyzed by Li-MAS-NMR (trade name: AVANCE 300, manufactured by Bruker Corporation). The results are shown in FIG. 2. From the results shown in FIG. 2, there was no peak at 1495 ppm to 1505 ppm in the spectrum of ⁶Li-MAS-NMR.

TABLE 2

| | | | | | Sur- |
|---|---|---|---|---|---|
| | | | | | face |
| | | | | | Mn/ |
| | | | | | Ni |
| | Li:Ni:Mn:Ti | | | | ratio |
| | (ICP) | a/Å | c/Å | c/a | (XPS) |
| Example 3 | 1.09:0.40:0.38:0.13 | 2.89293(12) | 14.3323(7) | 4.9543 | 1.06 |
| Example 4 | 1.09:0.40:0.38:0.13 | 2.89424(8) | 14.3366(6) | 4.9535 | 1.08 |

What is claimed is:

1. A cathode active material for a lithium secondary battery containing a lithium transition metal composite oxide as a main component,
wherein the lithium transition metal composite oxide is in a form of particles having a layered structure of a lithium layer and a transition metal-lithium layer,
the lithium transition metal composite oxide is expressed by General Formula (1): LiₘNiₓMn_{y}Ti_{z}O₂ (in the formula, m is in a range of 1.0<m≤1.1, x is in a range of 0.4≤x<0.5, y is in a range of 0.3<y<0.5, and z is in a range of 0<z≤0.133), and
as lattice constants (a, c, and c/a) of the lithium transition metal composite oxide, an a-axis length is 2.886 Å to 2.900 Å, a c-axis length is 14.29 Å to 14.35 Å, and c/a is 4.940 to 4.960.

2. The cathode active material for a lithium secondary battery according to claim 1, wherein in General Formula (1), m is in a range of 1.05≤m≤1.066, x is in a range of 0.4≤x≤0.475, y is in a range of 0.4≤y≤0.475, and z is in a range of 0.05≤z≤0.133.

3. The cathode active material for a lithium secondary battery according to claim 1, wherein a ratio (Mn/Ni ratio) of the number of atoms of Mn to the number of atoms of Ni on a surface of the particles of the lithium transition metal composite oxide is more than 1.0 and less than 2.5.

4. The cathode active material for a lithium secondary battery according to claim 1, wherein a peak intensity ratio of 1500 ppm/600 ppm is 0.15 or less in a spectrum of the lithium transition metal composite oxide which is measured by solid lithium nuclear magnetic resonance analysis (⁶Li-MAS-NMR) using a magic angle sample rotation method.

5. The cathode active material for a lithium secondary battery according to claim 1, wherein a peak due to lithium contained in the transition metal-lithium layer is not present at 1500 ppm in the spectrum of the lithium transition metal composite oxide which is measured by the solid lithium nuclear magnetic resonance analysis (⁶Li-MAS-NMR).

6. A lithium secondary battery comprising: a cathode; an anode; and an electrolyte, wherein the cathode contains the cathode active material for a lithium secondary battery according to claim 1.

7. The lithium secondary battery according to claim 6, wherein the electrolyte is a solid electrolyte.

8. A method for manufacturing the cathode active material for a lithium secondary battery according to claim 1, the method comprising:
heat-treating a mixture of a lithium compound, a titanium compound, and a nickel-manganese compound at 1000° C. to 1200° C. for 1 minute to 7 hours, or heat-treating a mixture of a lithium compound and a nickel-manganese-titanium compound at 1000° C. to 1200° C. for 1 minute to 7 hours.

9. The method for manufacturing the cathode active material for a lithium secondary battery according to claim 8, further comprising: subsequently holding the obtained lithium transition metal composite oxide at 850° C. to 950° C. for 3 hours to 12 hours after the heat-treating.
